(19) United States
(12) Patent Application Publication
(10) Pub. No.: US 2025/0330663 A1
(43) Pub. Date: Oct. 23, 2025

(54) BANDWIDTH PREDICTION USING MACHINE LEARNING

(71) Applicant: Hughes Network Systems, LLC, Germantown, MD (US)

(72) Inventors: Shuaipeng Dong, Germantown, MD (US); David Whitefield, Darnestown, MD (US); Naveen Gupta, Germantown, MD (US)

(21) Appl. No.: 19/081,355

(22) Filed: Mar. 17, 2025

Related U.S. Application Data
(60) Provisional application No. 63/635,222, filed on Apr. 17, 2024.
(60) Provisional application No. 63/698,022, filed on Sep. 23, 2024.

(51) Int. Cl. H04N 21/2385

(52) U.S. Cl. CPC H04N 21/2385

(57) ABSTRACT

Systems, methods, and apparatus, including computer-readable media, for bandwidth prediction using machine learning. In some implementations, a device detects a series of requests for streaming media content. The device generates a set of feature values based on times that the requests for the streaming media content were issued. The device provides the set of feature values as input to a machine learning model that has been trained to predict a time that a future request for media content will be issued. The device receives output of the machine learning model that indicates a predicted time of a subsequent request for the streaming media content or a predicted time to request bandwidth allocation for the subsequent request. Based on the output generated by the machine learning model, the device sends a bandwidth allocation request to allocate bandwidth to transmit data in a wireless network.

This application claims the benefit of priority to U.S. Provisional Patent Application No. 63/635,222, filed on Apr. 17, 2024, and to U.S. Provisional Patent Application No. 63/698,022, filed on Sep. 23, 2024, and the entire contents of the previous applications are incorporated by reference herein.

### BACKGROUND

The present specification relates to prediction of bandwidth needs by satellite terminals, including prediction of bandwidth for video streaming and other media streaming.

### SUMMARY

In some implementations, a computer system is used to train a machine learning model, such as a deep neural network, to predict the timing of requests that will be made during media streaming (e.g., video streaming, audio streaming, etc.). The machine learning model can be trained based on examples of time series data indicating the times of network requests made over the course of media streaming by different user devices, including potentially various different types of devices, browsers, applications, and video services. After the model has been trained, the model can be provided to satellite terminals (e.g., very small aperture terminals (VSATs)) and used by the satellite terminals to predict when upcoming requests will be made by the terminals. For example, the terminals can each locally detect when media streaming occurs, and each terminal can run the machine learning model to predict when the next request will be sent as part of ongoing streaming. The terminal can then predictively request bandwidth allocation in a satellite network before actually receiving a request to be sent in the network. As a result, the request can be sent and bandwidth allocation received in advance, so uplink bandwidth for the terminal has already been allocated before the terminal receives, from a user device streaming media, the next request for the terminal to send over the satellite network to a media streaming server.

By using the machine learning model to accurately predict the timing that the next media streaming request will be issued, the terminal can avoid the latency that would be incurred by requesting and receiving bandwidth allocation in response to receiving a streaming media request. For example, there is typically a round-trip delay between sending a bandwidth request and receiving a bandwidth allocation. Using predicted times that the machine learning model predicts new streaming media requests to be issued, terminals can send bandwidth requests in advance of the requests by the amount of average or predicted round-trip delay. As a result, terminals can receive bandwidth allocations shortly before streaming media requests are received from user devices, so that the delays to request and receive bandwidth allocations are not perceived by the user device and do not impact delivery of streaming media. This can reduce or avoid the occurrence of stutter or pausing in media playback.

Video streaming applications rely on bandwidth to promptly send out request packets through IP routers such as geosynchronous (GEO) satellite terminals. For GEO satellite networks with large number of terminals such as greater than 10,000 terminals per user beam, contention and bandwidth assignments are used to share the bandwidth among multiplexed satellite communications. Bandwidth requests and assignments play a significant role in video streaming applications and their end-user perceived video Quality of Experience (QoS), packets are queued inside terminal when the current bandwidth assignment is not enough to send out request packets for large video bandwidth. Since a GEO satellite terminal's request for bandwidth gets sent to its gateway (e.g., terrestrial satellite gateway) for its ground system through the satellite link, a GEO round trip delay for Bandwidth request and assignment can take more than 600 milliseconds.

To improve the quality of service during streaming, a terminal can use a deep learning (DL) prediction model to predict when the next video request packet will be issued by video streaming applications of devices communicating through the network connection(s) the terminal provides. The model's predictions enable terminals to request bandwidth just before it is needed and avoid waiting for the satellite round trip delay. For example, each terminal can locally store the model and use it to predict when the next Video TCP Request will be issued by an associated device or be received by the terminal. The terminal can then send a request for an amount of bandwidth that would permit transmission of a Video TCP Request at a time that is approximately 600 ms before the predicted issuance of the next Video TCP Request, so the bandwidth allocation has been made and received by the terminal by the time the next Video TCP Request arrives. As an example, models can achieve 90% accuracy in their predictions using a 10-second prediction window accuracy metric using a univariate time series, which enables low computation inside the satellite terminal for distributed computing.

In one general aspect, a method performed by a communication device includes: detecting, by the communication device, a series of requests for streaming media content; generating, by the communication device, a set of feature values based on times that the requests for the streaming media content were issued; providing, by the communication device, the set of feature values as input to a machine learning model, where the machine learning model has been trained to predict a time that a future request for media content will be issued based on input data indicating times that a sequence of previous requests for media content were issued; receiving, by the communication device, output that the machine learning model generated based on input of the set of feature values, the output indicating a predicted time of a subsequent request for the streaming media content or a predicted time to request bandwidth allocation for the subsequent request; and based on the output generated by the machine learning model, sending, by the communication device, a bandwidth allocation request to allocate bandwidth to transmit data in a wireless network.

In some implementations, the communication device provides network connectivity to a client device during playback of the streaming media content; and the series of requests includes multiple requests for the streaming media content from the client device that are spaced apart in time, and the set of feature values indicates a timing measure for each request in a group of consecutive requests from the series of requests, the group of consecutive requests includes the request for the streaming media content from the client device issued most recently before generating the set of feature values.

In some implementations, the timing measure for a particular request includes a measure of an amount of time that elapsed between the particular request and a reference time.

In some implementations, the reference time includes a time of a first request for the streaming media content during a current session of playback of the streaming media content.

In some implementations, the timing measure for a particular request indicates an amount of time between the particular request for the streaming media content and the request for the streaming media content in the series of requests that occurs immediately prior to the particular request in the series of requests.

In some implementations, the set of features values indicates a timing measure for each of a predetermined number of consecutive requests in the most recently received request for the streaming media content.

In some implementations, the streaming media content is a video; and the communication device is configured to repeatedly predict the timing of future requests for content of the video during a session of playback of the video, including by: detecting when requests for content of the video are issued; and for each request detected, using the machine learning model to predict (i) a time that a next request for content of the video will be issued during the session of playback of the video or (ii) a time to send a next bandwidth allocation request.

In some implementations, the communication device is configured to: determine, for each individual request for content of the video that is detected, a time to send a bandwidth allocation request for the corresponding next request for content of the video; and send, for each individual request for content of the video, a bandwidth allocation request at the determined time unless the next request for content of the video is detected before the determined time.

In some implementations, using the machine learning model includes: for each request detected, providing a set of feature values to the machine learning model, where the set of feature values includes values in a sliding window of previous requests; and each set of feature values includes values for a same size of the sliding window such that each set of feature values includes information about a same number of prior requests, and each set of feature values includes information about a different consecutive series of requests.

In some implementations, the method includes, after receiving the output that the machine learning model generated, monitoring, by the communication device, to detect additional requests for content of the streaming media. The communication device sends the bandwidth allocation request based on the communication device not detecting any additional requests for content of the streaming media between the most recent request used to generate the set of values and the predicted time indicated by the output of the machine learning model.

In some implementations, the method includes: scheduling, by the communication device, a time to send the bandwidth allocation request, where the scheduled time is set based on the output of the machine learning model. The communication device is configured to wait to send the bandwidth allocation request until the scheduled time and to selectively send the bandwidth allocation request to predictively allocate bandwidth to transmit the subsequent request for the streaming media, where the bandwidth allocation request is selectively sent according to whether the scheduled time occurs before the subsequent request is detected by the communication device.

In some implementations, the output of the machine learning model indicates a predicted time of the subsequent request for the streaming content, and the scheduled time is set to schedule transmission of the bandwidth allocation request at an offset before the predicted time of the subsequent request for the streaming content.

In some implementations, the offset is a predetermined amount of time, an amount of time based on a measure of latency in the wireless network, or an amount of delay between requesting and receiving allocations of bandwidth in the wireless network.

In some implementations, the bandwidth allocation request is sent separate from and independent of a transmission queue of data waiting to be transmitted by the communication device.

In some implementations, the communication device sends the bandwidth allocation request at a time that is determined based on the predicted time of the subsequent request for the streaming media content.

In some implementations, the method includes: after receiving the output of the machine learning model, delaying the sending of the bandwidth allocation request based on the predicted time of the subsequent request for the streaming media content, such that the bandwidth allocation request is sent at a time predicted to result in allocation of bandwidth at or within a predetermined amount of time before the occurrence of the subsequent request.

In some implementations, the communication device stores the machine learning model and runs the machine learning model locally to process the set of feature values and generate the output.

In some implementations, the method includes: receiving the machine learning model over the wireless network; and storing, by the machine learning model, the received machine learning model at the communication device. The providing the set of feature values includes providing the set of features values as input to the stored machine learning model.

In some implementations, the series of packets is a series of TCP request packets issued by a browser running a video application at a client device; and the predicted time is a predicted time of a subsequent TCP request packet for the streaming media issued by the browser running the video application at the client device.

In some implementations, the communication device is a satellite terminal, and the wireless network is a satellite communication network.

In some implementations, the communication device is a very small aperture satellite terminal.

In some implementations, the wireless network is a time-division multiple access (TDMA) network.

In some implementations, the output of the machine learning model includes a predicted bandwidth request size for the subsequent request; and the bandwidth allocation request requests an amount of bandwidth that is determined based on the predicted bandwidth request size.

In another general aspect, a method performed by one or more computers includes: collecting, by the one or more computers, data indicating sequences of requests issued by client devices during playback of streaming media content; generating, by the one or more computers, training data examples that each include (i) feature values indicating timing that requests occurred in a series of requests for streaming media content in a session and (ii) a corresponding value indicating a subsequent request for the streaming media content that occurred in the session after the series of requests; training, by the one or more computers, a machine learning model using the training data examples, where the machine learning model is trained to predict a time that a next request for streaming media content will be made based on input of feature values indicating times of a previous series of requests for streaming media content; and providing, by the one or more computers, access to the trained machine learning model, for one or more terminals to use the trained machine learning model to predict future request times during streaming media sessions.

In some implementations, providing access to the trained machine learning model includes providing the trained machine learning model for distribution to one or more terminals.

In some implementations, providing access to the trained machine learning model includes causing the trained machine learning model to be distributed to each of multiple terminals.

In some implementations, providing access to the trained machine learning model includes causing the trained machine learning model to be broadcast to each of multiple satellite terminals over a satellite communication network.

In some implementations, the machine learning model is configured to receive input values indicating times for each of a predetermined number of requests in a consecutive series, where the input values each indicate an amount of time that elapsed between the corresponding request and a shared reference time; and the machine learning model is configured to provide output that includes an output value that indicates a predicted amount of time between the next request and the reference time.

In some implementations, the model includes a neural network.

In some implementations, the neural network is a recurrent neural network.

In some implementations, the recurrent neural network includes multiple long short-term memory (LSTM) layers.

In some implementations, training the machine learning model includes biasing training to influence the model to predict the time of the next request to be before an actual time of the next request.

In some implementations, training the machine learning model includes training the model to predict times of subsequent requests with a distribution so at least 80%, at least 90%, at least 95%, or at least 99% of the distribution has predicted times before the actual times of the subsequent requests.

In some implementations, training the machine learning model includes training the model to predict times of subsequent requests with a distribution so at least 70%, at least 75%, or at least 80% of the distribution has predicted times before the actual times of the subsequent requests.

In some implementations, training the machine learning model includes training the model to predict times of subsequent requests with a distribution so at least 40%, at least 45%, or at least 50% of the distribution has predicted times before the actual times of the subsequent requests.

In some implementations, training the machine learning model includes training the machine learning model using an asymmetric loss function that uses different loss functions depending on whether the predicted time is before or after the time specified in the training example.

In some implementations, training the machine learning model using an asymmetric loss function includes splitting into two cases including (i) a first case represents prediction results before the actual time and (ii) a second case represents prediction results after the actual time, and where mean-squared error (MSE) is used to calculate loss during training for one of the two cases, and mean absolute error (MAE) is used to calculate loss during training for the other of the two cases.

In some implementations, training the machine learning model using an asymmetric loss function includes: using mean-squared error (MSE) to calculate loss during training for prediction results before the actual time; and using mean absolute error (MAE) to calculate loss during training for prediction results after the actual time.

In some implementations, training the machine learning model includes using a loss function during training that does not penalize predictions that are (i) earlier than a corresponding actual time of the next request and (ii) less than a predetermined threshold earlier than the corresponding actual time.

In some implementations, training the machine learning model includes setting a parameter that reduces the loss function for prediction results of the model that fall in a window of predetermined duration immediately before the actual time of the next request.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for bandwidth prediction by satellite terminals using machine learning.

FIGS. 2A-2C are examples of patterns of requests for streaming video content over time.

FIG. 3 is an example of predicted video request times and corresponding actual video request times.

FIG. 4 is a diagram showing an example of a prediction of the time of a video request.

FIGS. 5A and 5B are diagrams showing examples of time series data used for bandwidth prediction.

FIGS. 6A and 6B are diagrams showing examples of requests and normalized timing for video requests, as well as the measures for inter-packet request time and adjusted start request time.

FIG. 7 is a diagram that shows an example custom loss function using mean squared error and mean absolute error for different cases.

Like reference numbers and designations in the various drawings indicate like elements.

### DETAILED DESCRIPTION

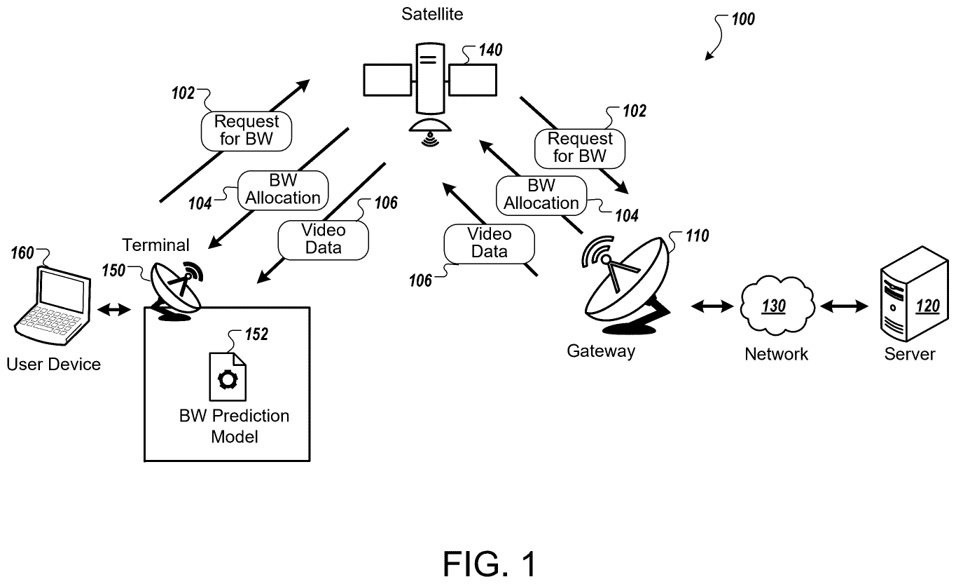

FIG. 1 is a diagram showing an example of a system 100 for bandwidth prediction by satellite terminals using machine learning. The system 100 includes a satellite terminal 150 (e.g., a VSAT) that communicates over a satellite network connection provided by a satellite 140 and a satellite gateway 110. The gateway 110 enables communication with a network 130, such as the Internet, so that devices can communicate with one or more servers, such as the server 120. The terminal 150 provides a network connection to one or more other devices, such as the user device 160.

For simplicity only a single user device, terminal, satellite, gateway, network, and server are shown. However the system 100 can include multiple user devices that receive a network connection through the same terminal 150. Similarly, there can be multiple terminals that each provide network connections to their respective user devices. Similarly, there can be multiple satellites, gateways, networks, and/or servers.

In the example, the user device 160 streams a video provided by the server 120. Requests from the user device 160 are provided to the terminal 150, which sends them via the satellite 140 to the gateway 110, which provides the requests through the network 130 to the server 120. Similarly, video data from the server 120 is sent through the network 130 to the gateway 110, then through the satellite connection via the satellite 140 to the terminal 150, which provides the video data to the user device 160.

When a terminal 150 requests bandwidth via a satellite link to the gateway 110 (e.g., ground system) and receives the indication of the allocated bandwidth, the round trip for the request and assignment can take as much as 600 milliseconds (e.g., approximately 300 ms for the bandwidth request to reach the gateway 110 and another approximately 300 ms for the bandwidth allocation message sent in response to reach the terminal 150).

Waiting on GEO satellite round-trip delay in bandwidth request and assignment significantly slows down video streaming leading to video buffering causing degradation in user quality of experience (QoE). For example, an end-user watching a video in their web browser may see a spinning buffering symbol while they wait for the bandwidth assignment and subsequent video frames to be downloaded via the satellite terminal.

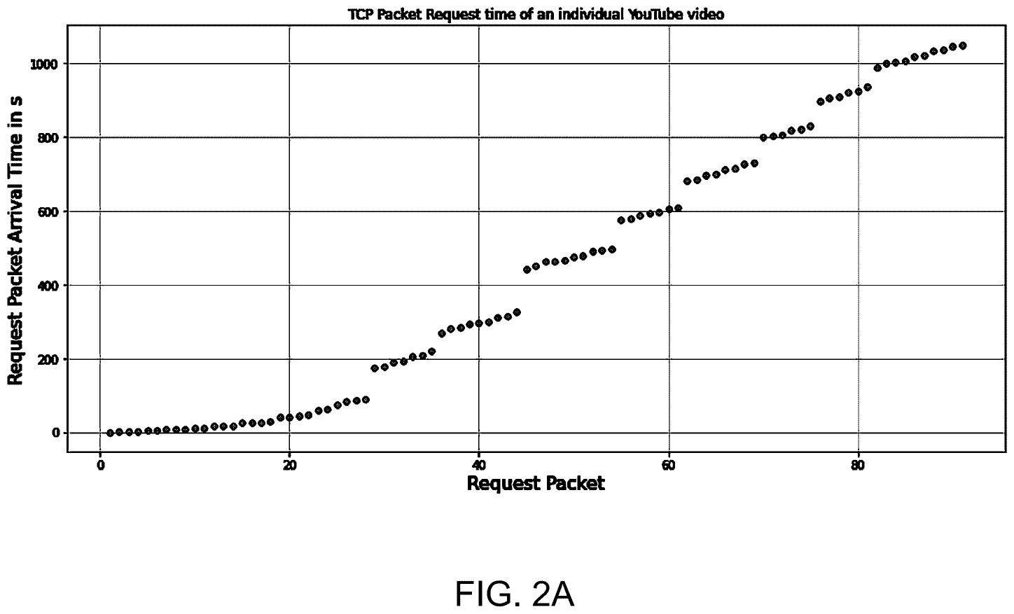

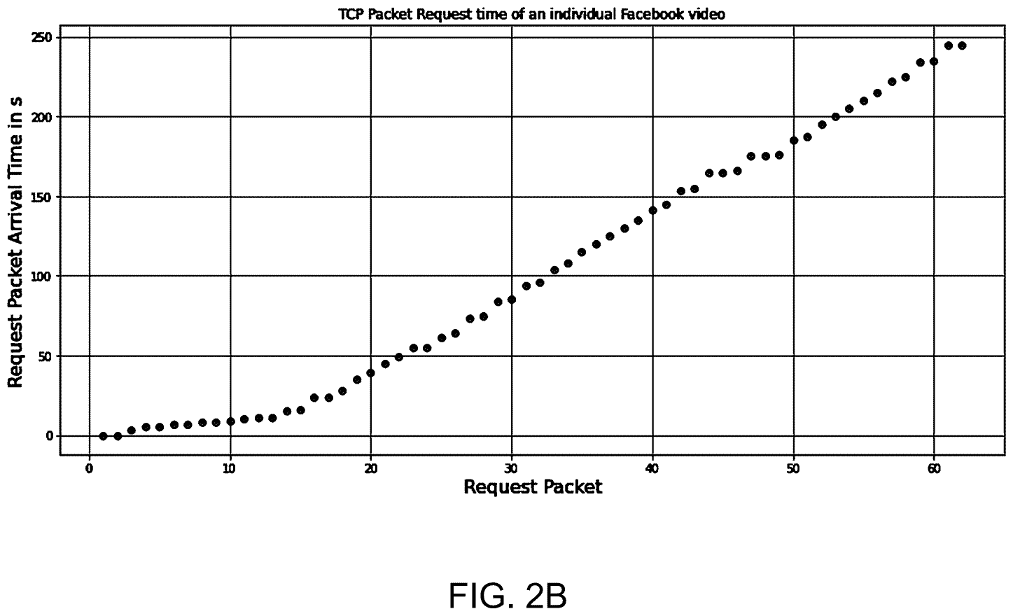

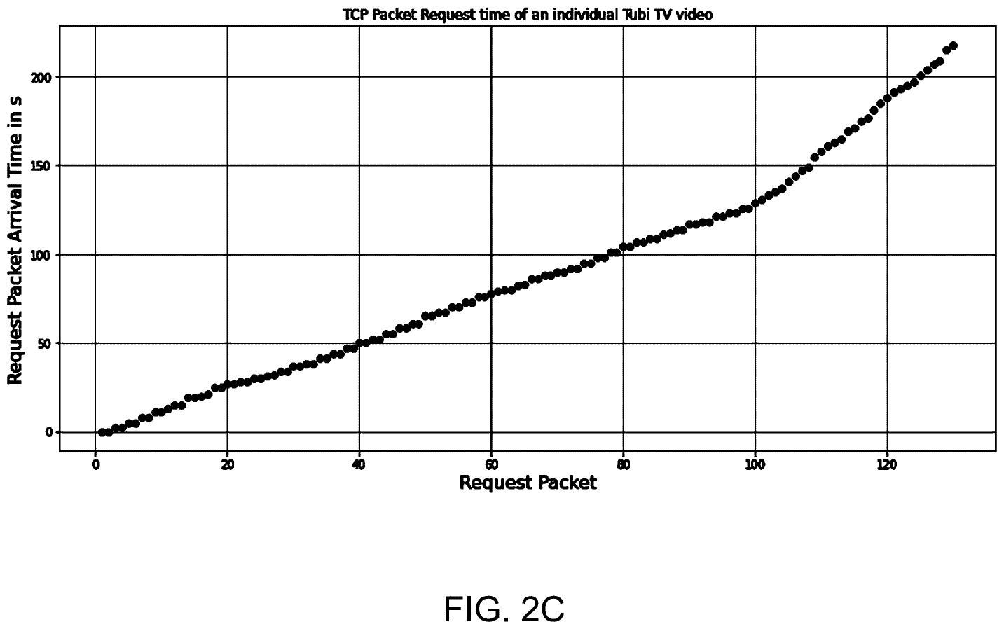

When the terminal 150 streams video or other media, the media is often retrieved in pieces over the course of the streaming session. For example, the terminal 150 sends a series of requests for portions of the video as needed to initially fill a local video buffer and then to replenish the buffer as the video is presented. FIGS. 2A-2C show different examples of video data requests over time over the course of video streaming. Different video streaming services and different client configurations (e.g., different operating systems, applications, web browsers, hardware capabilities, etc.) can result in different patterns of request timing during streaming. As an example, FIG. 2A shows the typical bursting behavior of TCP request packets generated by a user device streaming a video through YouTube. The example shows a grouping of TCP requests that represents a burst of requests happening in a short interval of time. For example, the initial series represents requests for video chunks that fill a local buffer, and then later groupings are clusters of requests to replenish the content in the local video buffer as time goes on. FIG. 2B shows TCP packet request times for a Facebook video, and FIG. 2C shows TCP packet request times for a video from Tubi TV.

When a user is streaming videos or other media, the bandwidth required needs to increase at times in order to send large request packets to the gateway 110 and video servers 160 through the satellite terminal 150. However, the terminal 150 needs to wait until more bandwidth is allocated to it before the terminal 150 can send the request packets, which can cause lagging and other issues when streaming. To avoid playback disruption, a machine learning model 152 can be used to predict beforehand when the video player on the user device 160 will send out the next video data request. The terminal 150 can send the bandwidth request before the actual video data request is issued, reducing latency and making video streaming experience smoother.

A computer system can collect information about the timing of data requests during streaming, such as by monitoring traffic during client streaming or by using a simulated environment is set up to collect data about the timing and content of requests (e.g., TCP packets with video data requests). This data can be used to train a machine learning model 152 that is then transmitted to or deployed to terminals 150. For example, a workstation, a server system, data center, cloud computing system or other system can be used to create and train the model 152, which can be sent to the terminal 150 (e.g., over the satellite network or another network) or can be loaded when the terminal 150 is manufactured.

As an example, data collection can be performed using a simulated runtime environment to collect data on multiple video-streaming service providers requests. Multiple terminals can be setup using a satellite terminal and modem. In the lab setup, the terminals are each connected to a client device that runs python scripts to automatically play videos from multiple video streaming service providers (e.g., Facebook, YouTube, Tubi TV). The data is captured and analyzed at an interval (e.g., every second), to extract terminal-level and browser-level information. In some implementations, the system utilizes only terminal-level information, because the model 152 is running inside the terminal 150. For a training and/or testing dataset, the video service providers are determined with scripts running inside the client device to identify which video service provider's content is currently playing. For real world applications, the terminals, at IP packet layer, have additional models and deep packet inspector with domain name matching analysis to determine the video service provider and to identify the start of video streams.

After data is captured, the system processes the data in the following way. First, the system can group each individual request by its video_id, which represents individual videos, such that TCP packets from each group are from the same video source. Then, the system sorts each packet in each group based on its start_request_time, which is the arrival time of each TCP packet in the terminal.

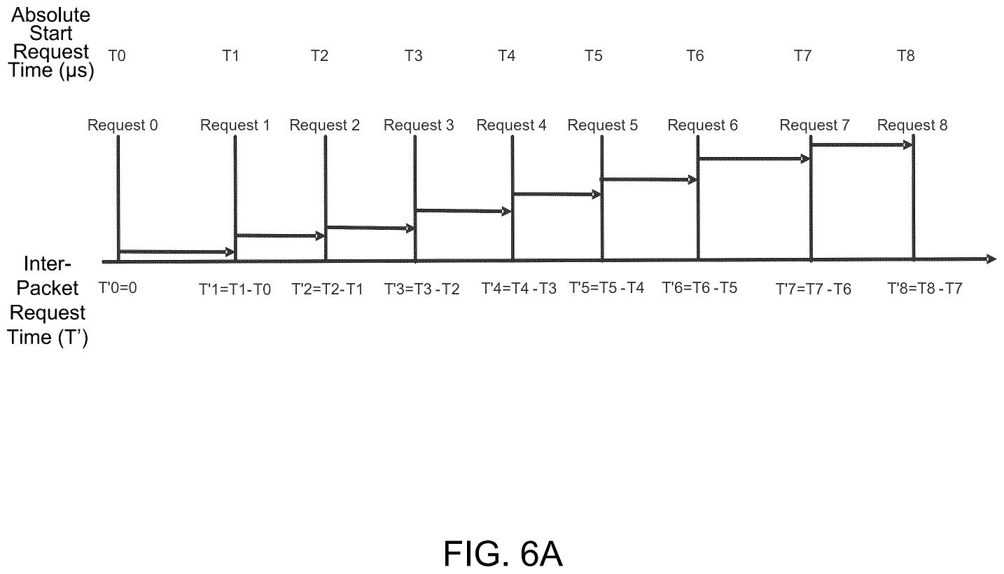

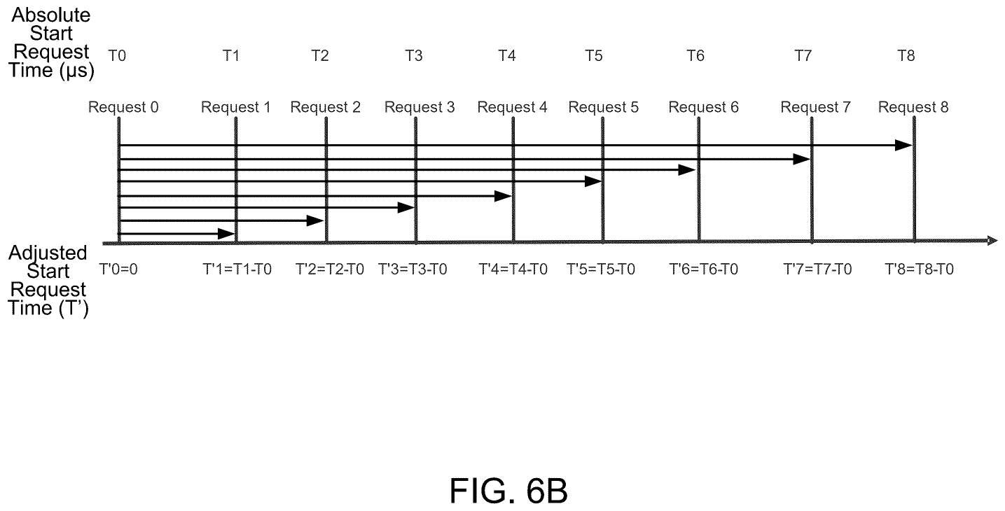

To prepare training data, the system can perform feature extraction to determine a set of feature values corresponding to TCP request packet. Each of the individual video sessions are processed to extract features (e.g., input to the model 152) and ground truth results (e.g., a label or training target for the training example) for training and testing purposes. Given the predictive or pre-emptive approach, the features the system can use are limited to client request information of each TCP packet, such as packet arrival time, request size, sequence number, and satellite metrics available to the terminal. First, the system can extract the arrival time of the TCP request packets and calculate the adjusted_start_request_time by setting the first request packet of each individual video session as a reference timestamp and calculate the offset with all the other packets in that video session as shown in FIG. 6B.

Then the system calculates the inter_packet_request_time by calculating the difference in time between each of the consecutive TCP request packets of each individual video session, setting the first request packet with value 0, as shown in FIG. 6A.

The system then determines the request size of each request packet, creating a training dataset so that each training example has three features: adjusted_start_request_time, inter_packet_request_time, and request size. In some implementations, a subset of these features are used for training and prediction. For example, only adjusted_start_request_time may be used, or only the inter_packet_request_time may be used.

Next, the system splits the dataset into Training, Validation and Testing sets, for example, with a training split of 70% and validation/testing split of 15%. To maintain the integrity of dataset, the system can split the dataset based on each of the individual streaming services, by keeping 70% of each individual streaming service in the training set and 15% of each in the validation/testing set.

Then, the system can normalize the data to feed into the model 152. Min-Max normalization was used:

$${x}_{normalized} = \frac{x - min ( {x}_{train} )}{max ( {x}_{train} ) - min ( {x}_{train} )}$$

Normalization is helpful to preserve the original distribution of the data, which is important given that each of the video streaming services has its own representative trend in the corresponding distribution.

The machine learning model 152 allows the terminal 150 to predict the next arrival time of request packets to be sent by the video streaming application on the user device 160 via the terminal 150. The machine learning model 152 utilizes a recurrent neural network architecture and a custom loss function for a univariate time series.

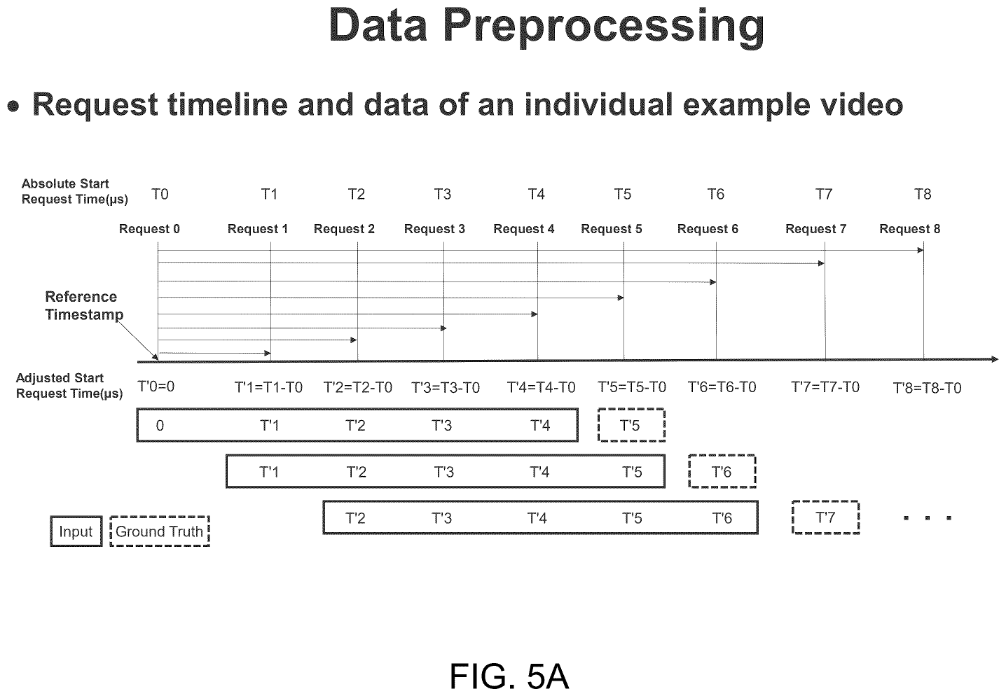

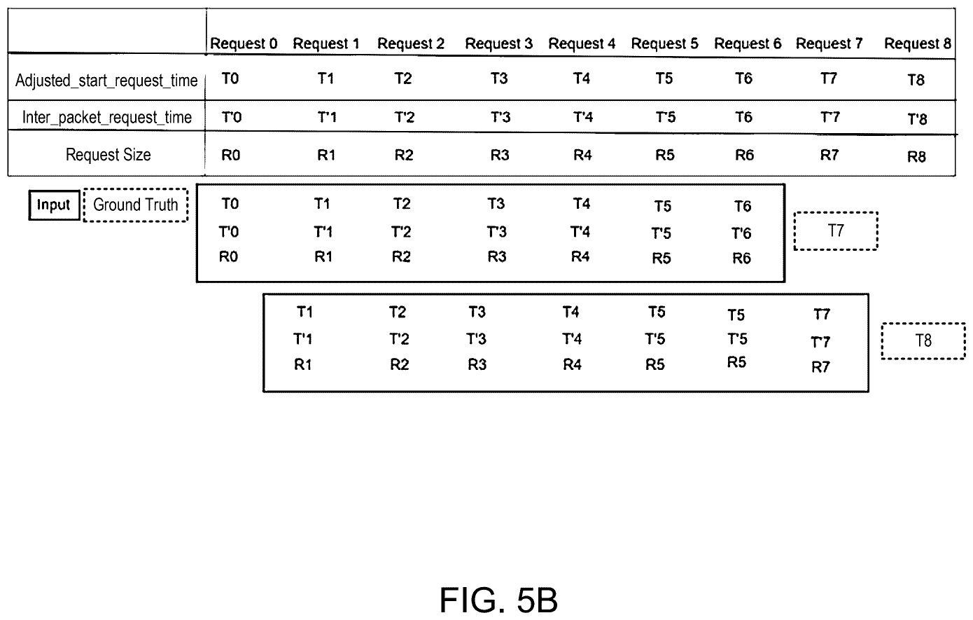

Due to the nature of video TCP requests, each individual video can be processed separately. The machine learning model 152 can be configured to receive input of values about the timing of the previous n requests, where n is an integer. For example, for training of the model 152 and for inference processing, the model 152 receives input of a time series of requests using a sliding window with a window size of 5. The time of the first request can be set as a first timestamp as reference timestamp and can be used to calculate an offset to indicate the times of other requests. For example, the input to the model 152 can be a sequence of values, each indicating an amount of time with respect to a reference time. In some implementations, e.g., FIG. 5A, the times of requests are indicated relative to the same fixed reference time (e.g., the first request in the streaming session). In other implementations, e.g., FIG. 6A, the times of requests are indicated relative to the previous request, so that each request time is specified as the amount of time elapsed since the previous request.

In some implementations, the model 152 is trained to predict a value of the adjusted start request time, which represents the amount of time that has elapsed since the first TCP request packet for the current video streaming session. For example, the input to the model 152 can include the adjusted start request times of a sliding window of the most recent requests (e.g., the series of 7 consecutive requests most recently received). The model 152 can then predict the adjusted start request time that the next TCP request packet will be received. In this way, the input values and the output value are each amounts of time that has elapsed relative to the same reference time, e.g., the time of the first TCP request packet for the video. For example, the input to the model 152 for a prediction may include a vector of the most recently received TCP requests, e.g., [120, 141, 165, 177, 189, 205, 230] (described here in seconds), and the output can be a prediction of the next TCP request time relative to the first TCP request, e.g., 252 seconds. As an alternative, the inputs and outputs can indicate times relative to another reference time.

The model 152 can be trained using a mean squared error (MSE) loss function. For example, a traditional mean squared error (MSE) loss function can be expressed as:

$$MSE = \frac{1}{n} {\sum }_{i = 1}^{n} {( {Y}_{i} - {\hat{Y}}_{ι} )}^{2}$$

$$* {Y}_{i} Model Prediction$$

$$* {\hat{Y}}_{i} Ground Truth$$

To improve accuracy, the model 152 can be implemented using a custom loss function:

$$Custom MSE = \frac{1}{n} {\sum }_{i = 1}^{n} ( {( {Y}_{i} - {\hat{Y}}_{i} )}^{2} + Max ( 0 \text{.0} , ( {Y}_{i} - {\hat{Y}}_{i} ) ) )$$

$$* {Y}_{i} Model Prediction$$

$$* {\hat{Y}}_{i} Ground Truth$$

Traditional MSE calculates the squared difference between the ground truth and model prediction. However, this may result in at least some predictions erring by being later than the actual time the video data request is issued. In other words, if prediction errors are distributed around the actual request times, many predicted video request times will be after the corresponding actual request times, so that some latency is still incurred. To improve the likelihood that predicted times are before the actual times, the traditional MSE can be biased toward earlier predictions, to shift the predictions toward earlier times that will be before the actual video data requests. For example, in the custom MSE, the traditional MSE has been modified to add linear positive error if the prediction value is greater than ground truth time (e.g., a late prediction), so the custom MSE favors early prediction.

In some implementations, the training process uses a loss function that is asymmetric in the loss calculation for predictions that occur before the ground truth time (e.g., early predictions) and after the ground truth time (e.g., late predictions). Because of the model's predictive or anticipatory nature, it is preferable to bias the training so that the inference made by the model tends to predict the next request as occurring slightly earlier than the real arrival time of TCP request packets. This can allow the terminal to make an offset bandwidth request and assignment time before it is needed, so that upon arrival of the real TCP request packet, there is enough bandwidth just-in-time for that terminal to send out the new TCP request packet without waiting. To achieve this capability, the training process for the model 152 can use a custom loss function that penalizes late predictions more heavily than early predictions.

As an example, the loss function can include use both Mean-Squared Error (MSE) and Mean-Absolute Error (MAE).

A traditional mean squared error (MSE) loss function can be expressed as:

$$MSE = \frac{1}{n} {\sum }_{i = 1}^{n} {( {Y}_{i} - {\hat{Y}}_{ι} )}^{2}$$

$$* {Y}_{i} Model Prediction$$

$$* {\hat{Y}}_{i} Ground Truth$$

A traditional mean absolute error (MAE) loss function can be expressed as:

$$MAE = \frac{1}{n} {\sum }_{i = 1}^{n} ( {Y}_{i} - )$$

$$* {Y}_{i} Model Prediction$$

$$* {\hat{Y}}_{i} Ground Truth$$

Note that mean absolute error is generally defined with an absolute value operator applied to the difference (e.g., |Yi−Ŷi|), so the difference error result is always positive. However, because the custom loss only uses MAE when the error is positive (e.g., late), such as taking the maximum value of zero and the difference (e.g., max(0.0, (Yi−Ŷi))), the absolute value operator is not needed in this case.

The custom loss function uses both MSE and MAE, with different functions used to calculate loss for predictions at different sides of the ground truth time. For example, MSE can be used for early predictions and MAE can be used for late predictions. The custom loss can also use a forgiveness parameter, t, that represents an amount of time before the ground truth time in which an early prediction will not be penalized. For example, the forgiveness parameter can be set to a predetermined value, such as 3 seconds, 5 seconds, etc. to specify a time range that extends up to the ground truth request time in which predictions can be acceptably early. This helps train the model with a window of predetermined length where predictions can be earlier than the ground truth timing of a training example and still be considered valid or appropriate times for predicting the occurrence of the next request (or predicting a time to send a request for allocation of bandwidth for the next request for content). The custom loss function can be as follows:

$$Loss = \frac{1}{n} {\sum }_{i = 1}^{n} ( Max ( 0 \text{.0} , ( {Y}_{i} - {\hat{Y}}_{i} ) ) + {Max ( 0 \text{.0} , ( {\hat{Y}}_{i} - {Y}_{i} - τ ) )}^{2} )$$

$$* {Y}_{i} Model Prediction$$

$$* {\hat{Y}}_{i} Ground Truth$$

$$* τ Forgiveness Parameter$$

Comparing to Traditional MSE (which calculates the squared difference between the Ground Truth and Model Prediction) and MAE (which calculates the absolute difference between Ground Truth and Prediction), the custom loss function can adjust the condition of loss punishment, separating late prediction and early prediction, where (1) the MAE part of the custom loss function applies for late prediction, and (2) the MSE part of the custom loss function applies for early prediction. The custom forgiveness parameter avoids penalizing predictions that are forgiven by the model training process (e.g., not penalized) because the predicted time is sufficiently close to the ground truth time (e.g., within a predetermined threshold).

The model 152 has the advantages of being lightweight and able to run prediction and inference on a satellite terminal 150 with limited power consumption and limited computing resources, while also achieving high accuracy in predicting video request packet times. The approach utilizes a distributed computing approach where each terminal 150 performs its own local embedded prediction operations using its own local copy of the model 152.

An example of results is shown in the table below. This example shows results of evaluation of the model with a test set and accuracy window metrics. The accuracy window metrics are measured based on the percentage of predictions that are earlier than the ground truth within a threshold. The thresholds evaluated in the example below are 5 and 10 seconds from the ground truth. As shown below, the model trained with the dual MSE/MAE custom loss function is able to achieve above 50% accuracy in accurately predicting within a 5 second time window and 89.76% accuracy in hitting the 10 second time window earlier than the actual request time. This allows the terminal to pre-emptively make the bandwidth request just in time before the subsequent TCP package actually arrives at the terminal so that that bandwidth request and assignment is already performed. With only a 0.01% late prediction, the terminal is able to effectively request bandwidth earlier than the actual request which attempts to avoid waiting on the round-trip delay of bandwidth request and assignment time via the GEO satellite link.

Accuracy Metric
Prediction Window for Test Set

| Prediction | Early | In | Late |
|---|---|---|---|
| Window | Window | Window | Window |
| 5 Second | 41.02% | 58.97% | 0.01% |
| 10 Second | 10.23% | 89.76% | 0.01% |

The machine learning model 152 can include two or more layers of long short-term memory (LSTM) nodes. The model 152 can use a gated recurrent neural network for sequence processing, with internal states for input, output, update, feedback, and forget. Training can be performed using stochastic gradient descent or other techniques to set the values of neural network weights and/or other parameters.

The machine learning techniques predict the next arrival time of request packets to be sent by the video streaming application via the terminal. The machine learning model 152 utilizes a Recurrent Neural Network (RNN) architecture and custom loss function. An RNN provides a feedback loop of intermediate and output values from each neural network layer for each step in the window size. The use of Long Short-Term Memory (LSTM) layers as a variation of a RNN are used in the model to provide a gated variation that dampens and controls the inputting, updating, forgetting, feedback, and outputting of the model internal weights used for predictions.

In some implementations, the model 152 can be a multi-layer (e.g., three-layer) LSTM with an output dense layer and (rectified linear unit) ReLU activation. The model 152 can be paired with the custom loss function with an Adam optimizer (e.g., Adaptive Moment Estimation, a stochastic gradient descent method based on adaptive estimation of first-order and second-order moments) and learning rate scheduling. Compared to other large scale traffic pattern analysis and prediction solutions, this solution is smaller and more lightweight and so is able to run prediction or inference on a terminal (e.g., a VSAT) with limited computing power and achieving high accuracy in predicting the next video request packet time. The approach utilizes a distributed computing approach where each terminal performs its own local embedded prediction. Parameters of an example model architecture are shown in Table 1 below.

TABLE 1
Model Architecture
Model: LSTM Model

| Layer (type) | Output Shape | Param # |
|---|---|---|
| LSTM | (None, None, 512) | 1,052,672 |
| LSTM | (None, None, 512) | 2,099,200 |
| LSTM | (None, 512) | 2,099,200 |
| Dense | (None, 1) | 513 |
| Total params: | 5,251,585 | |
| Trainable params: | 5,251,585 | |
| Non-trainable params: | 0 | |

The model 152 has shown improved performance compared to other types of models, such as a random forest regressor. Example results showing the improved performance of the model 152 based on a LSTM are shown below.

| | LSTM | RF | |
|---|---|---|---|
| Scoring Metrics | Model | Regressor | |
| R2 score (Default) | 0.99 | 0.39 | LSTM |
| 0 (worse)-1 (better) | | | |
| MAE | 0.0041 | 0.0076 | LSTM |
| Custom Loss | 2.52 × 10⁻⁵ | 3.86 × 10⁻³ | LSTM |

Various other additions or variations can be made to extend or enhance the model. For example, satellite link quality metrics can be incorporated into training of the model 152 and as additional inputs to the model 152 during training and inference. An example of link quality includes the ratio of negative acknowledgements versus positive acknowledgements. This can address satellite link fades or degraded links that may cause retransmissions or missed packets that may adversely impact the next TCP request times during these short time periods. Other measures such as recent or historical values for latency, SINR, throughput, or other measures can also be used in the training and predictions of the model.

The impact of different video resolutions and different bandwidth request amounts from standard or common video resolutions can be used as additional variations of training data to predict not only the next TCP request times but also the next predicted bandwidth request size. The terminal 160 can be configured to vary the amount of bandwidth requested based on the request size predicted by the model.

In addition, indicators of client environments, client browsers, client operating systems, and client or user computers can also be included in the training data and in input for making predictions, to account for the impact of variations of these factors. The terminal 160 can utilize separate prediction ML models for predicting these characteristics (e.g., to detect or predict which client environment or browser is being used) for a media stream, and the predicted characteristics can be provided as inputs to the request time prediction model 152. For example, another model can predict a client environment based upon the visible MAC address prefix of the client computer whose TCP packets are being locally routed by the satellite terminal on its local wireless network or LAN.

In many cases, advertisements disrupt the smooth flow of video streams since video applications may flush their video buffers when video ads are injected and played as part of a video stream. This disruption can cause failures or inaccuracies in TCP request time predictions. Different video streaming providers behavior in handling of advertisements can be captured, and the system can train the model 152 to use indicators of which video service is involved to more accurately predict bandwidth request arrival times for specific video services.

Region handling and variations associated with different regions such as different countries, states, regions, or satellite spot beams need to be accounted for in production deployments of this ML model 152 via the collection and possible synthetic generation of training data to be sufficiently representative of these variations.

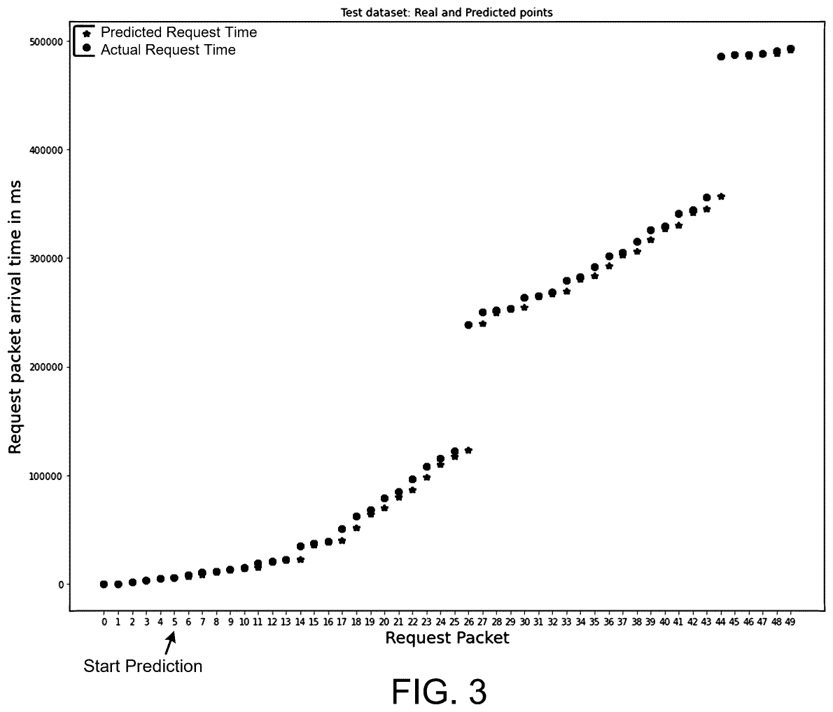

FIG. 3 is an example of predicted video request times and corresponding actual video request times. FIG. 3 shows an example of prediction vs ground truth of an individual video. The star symbols represent predictions of the arrival time of the next video request packets, and the filled circles represent instances of actual video requests being received by the terminal 150 from the user device 160.

The techniques can be used to process the relative timestamp of individual streaming video sessions. A recurrent neural network can be created for forecasting next TCP request. For training that neural network, a custom loss function can be used to force model prediction to bias towards early prediction. With the custom loss function of the model, predictions are biased so that most or even all request times predicted are before the actual ground truth times, so that the terminal 150 has sufficient time to pre-emptively make the bandwidth request before the bandwidth is actually needed. This leads to improved video QoE since the terminal 150 can have the anticipated bandwidth ready when needed to keep the video streaming smooth with minimal buffering.

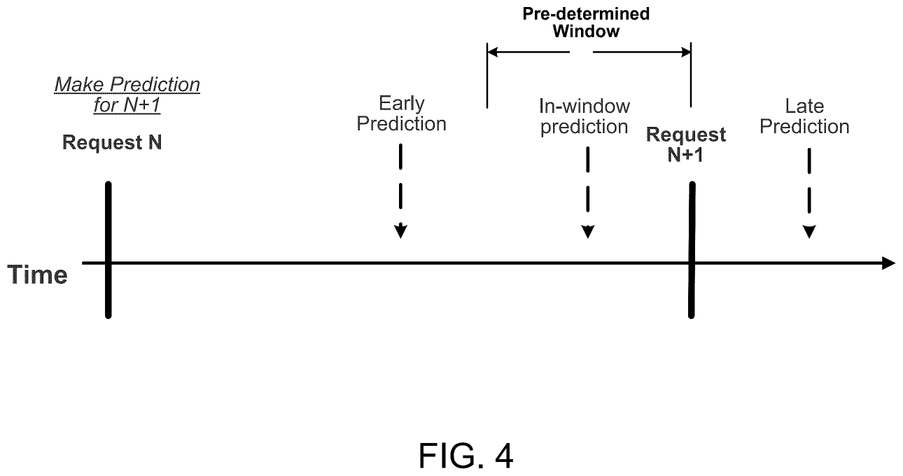

FIG. 4 is a diagram showing an example of a prediction of the time of a video request. After each video request, the terminal 150 can use the model 152 to predict the next time of the next video request. For example, after a request N, the terminal 150 uses the model 152 to predict the time of the next request N+1. To make the prediction, the terminal 150 provides a set of feature values that indicates the time of the five previous requests, e.g., the times of requests (or amount of time since the previous request) for the requests N, N−1, N−2, N−3, N−4.

In response, the model 152 provides an output value that indicates the predicted time of the upcoming request N+1. This can be in the form of a value that indicates an amount of time with respect to a reference time, which can be the time of the immediately previous request (e.g., Request N), or another reference time, such as the time of the first video request in the streaming session.

When the terminal 150 determines a predicted time of the next video data request, the terminal 150 sends a request for uplink bandwidth at a time in advance of that predicted time. For example, the terminal 150 may have an offset value that represents a recent, average, or predicted amount of time delay for a round-trip process to request and obtain bandwidth allocation. The terminal 150 then accounts for the likely delay by requesting bandwidth at a time that is based on the predicted video request time and the offset time, e.g., at a time that is the predicted video request time minus the offset time.

Ideally, predictions specify a time that is before the upcoming request N+1 but less than the forgiveness time before the upcoming request N+1. This is reflected in FIG. 4 as a window being targeted for the prediction to occur. Before this window, the bandwidth allocation may be too soon to be used effectively. Although an early allocation may still be used by the terminal 150 to send data, and so may not be wasted, it may not contribute to reducing latency for the video streaming. Similarly, predicted times after the actual request still provide bandwidth allocations that could potentially be used for other needs, but the incorrectly predicted bandwidth allocation request still would likely incur some delay while waiting for its allocation to be received.

FIG. 5A is a diagram showing an example of time series data used for bandwidth prediction. When generating examples for training, individual data points can be expressed as a value indicating the time of a request and the set of times for requests in a sliding window immediately preceding the request. For example, a univariate time series can be used, where the sliding window encompasses five requests. To prepare data for training, the system slides the input window of size 5 requests, element by element, and construct the input to model. The data pairs created this way can be shuffled so that they are mixed or interspersed, so the order they are used in training is different from the order they occur in videos. The system can normalize the data by min-max normalization, keeping the original distribution.

In some implementations, training data examples include other values such as information about the user device and its configuration, e.g., operating system (OS), OS version, web browser used, web browser version, application used, application version, video service used, etc. The model 152 can be configured to receive, as input, values indicating user device configuration or information derived from network traffic that is indicative of the configuration. These values can be provided during training and during inference to enable the model 152 to better predict the pattern and timing of video data requests, which can vary depending on the user device state or configuration and which video service is being used.

FIG. 5B shows another example of applying a sliding window to a set of feature values to generate input to the model 152. The sliding window approach can be used for defining training examples as well as for determining input to process to make a inference prediction.

The example shows a window size of 7, which groups each 7 consecutive requests' features as input to the model 152. For training, the next request packet's adjusted_start_request_time is set as the ground truth value. The system then slides the window by one, then constructs the next input and corresponding ground truth label, until the end of an individual session. The system then moves on to the next session, across training, validation, and test datasets.

After experimentation, results indicate that using the adjusted_start_request_time alone can produce similar results compared to using all three types of the features. This gives the advantage of using fewer and lighter features, because fewer input features results in lower computational demands in the terminal for each prediction.

FIG. 6A is a diagram showing an example of requests and normalized timing for video requests. In some implementations, the values used to represent timing of video requests can be expressed as time periods between packets, e.g., an inter-packet request time representing the delay since the previous video request packet. This type of relative measure of timing can be determined and used for the inputs to the model 152 during training and for inference (e.g., generating predictions during video streaming). The symbols T0, T1, T2, T3, etc. represent the actual time of the various requests numbered 0, 1, 2, 3, etc. The inter-packet request time is denoted as “T′” and is calculated as the elapsed time since the immediately previous request in the session. For example, the inter-packet request time for request 2 is labeled T′2 and is calculated as T2-T1; the inter-packet request time for request 3 is labeled T′3 and is calculated as T3-T2; and the other values are calculated in a similar manner.

FIG. 6B shows an example of calculation of adjusted start request times, which can be used as features as input to a machine learning model in addition to or instead of the inter-packet request time shown in FIG. 6A. The adjusted start request times each represent the amount of time since the beginning of the streaming session, e.g., since the time of the first request T0 in the streaming session. The symbols T0, T1, T2, T3, etc. represent the actual time of the various requests numbered 0, 1, 2, 3, etc. The adjusted start request time is denoted as “T′” and is calculated as the elapsed time since the first request in the session. For example, the adjusted start request time for request 2 is labeled T′2 and is calculated as T2-T0; the adjusted start request time for request 3 is labeled T′3 and is calculated as T2-T0; and the other values are calculated in a similar manner.

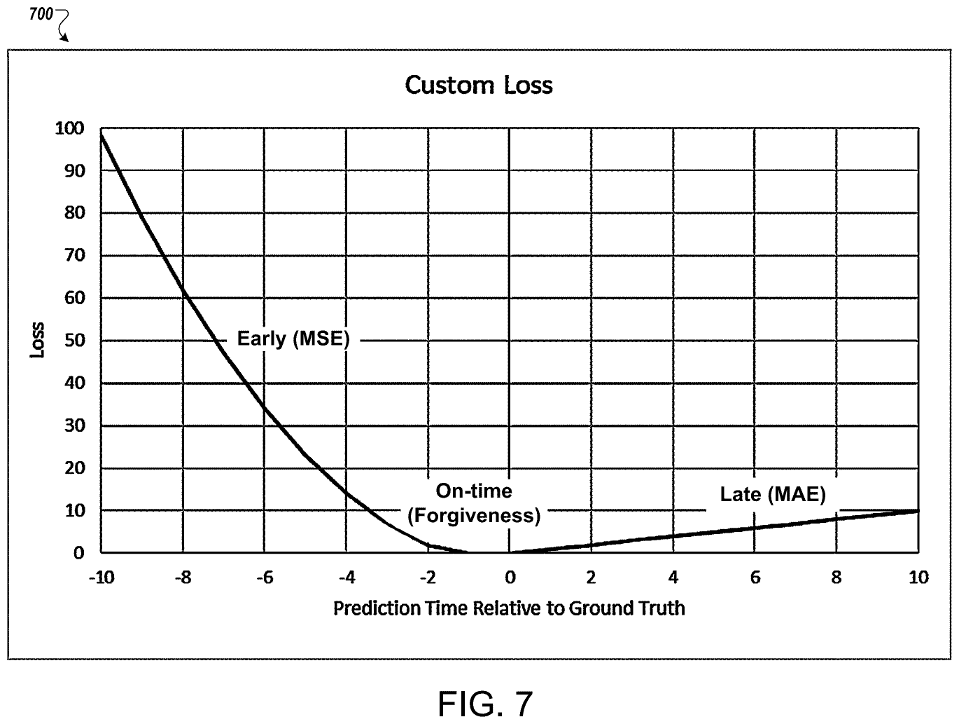

FIG. 7 is a diagram that shows an example custom loss function using mean squared error (MSE) and mean absolute error (MAE) for different cases. As illustrated, MSE can be used in training for the case of early predictions, and MAE can be used in training for the case of late predictions.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the invention have been described. Other embodiments are within the scope of the following claims. For example, the steps recited in the claims can be performed in a different order and still achieve desirable results.

1. A method performed by a communication device, wherein the method comprises:
detecting, by the communication device, a series of requests for streaming media content;
generating, by the communication device, a set of feature values based on times that the requests for the streaming media content were issued;
providing, by the communication device, the set of feature values as input to a machine learning model, wherein the machine learning model has been trained to predict a time that a future request for media content will be issued based on input data indicating times that a sequence of previous requests for media content were issued;
receiving, by the communication device, output that the machine learning model generated based on input of the set of feature values, the output indicating a predicted time of a subsequent request for the streaming media content or a predicted time to request bandwidth allocation for the subsequent request; and
based on the output generated by the machine learning model, sending, by the communication device, a bandwidth allocation request to allocate bandwidth to transmit data in a wireless network.

2. The method of claim 1, wherein the communication device provides network connectivity to a client device during playback of the streaming media content; and
wherein the series of requests comprises multiple requests for the streaming media content from the client device that are spaced apart in time, and wherein the set of feature values indicates a timing measure for each request in a group of consecutive requests from the series of requests, wherein the group of consecutive requests includes the request for the streaming media content from the client device issued most recently before generating the set of feature values.

3. The method of claim 1, wherein the timing measure for a particular request comprises a measure of an amount of time that elapsed between the particular request and a reference time.

4. The method of claim 3, wherein the reference time comprises a time of a first request for the streaming media content during a current session of playback of the streaming media content.

5. The method of claim 4, wherein the timing measure for a particular request indicates an amount of time between the particular request for the streaming media content and the request for the streaming media content in the series of requests that occurs immediately prior to the particular request in the series of requests.

6. The method of claim 1, wherein the set of features values indicates a timing measure for each of a predetermined number of consecutive requests in the most recently received request for the streaming media content.

7. The method of claim 1, wherein the streaming media content is a video; and
wherein the communication device is configured to repeatedly predict the timing of future requests for content of the video during a session of playback of the video, including by:
detecting when requests for content of the video are issued; and
for each request detected, using the machine learning model to predict (i) a time that a next request for content of the video will be issued during the session of playback of the video or (ii) a time to send a next bandwidth allocation request.

8. One or more non-transitory machine-readable media storing instructions that are operable, when executed by one or more processors of a communication device, to cause the communication device to perform operations comprising:
detecting, by the communication device, a series of requests for streaming media content;
generating, by the communication device, a set of feature values based on times that the requests for the streaming media content were issued;
providing, by the communication device, the set of feature values as input to a machine learning model, wherein the machine learning model has been trained to predict a time that a future request for media content will be issued based on input data indicating times that a sequence of previous requests for media content were issued;
receiving, by the communication device, output that the machine learning model generated based on input of the set of feature values, the output indicating a predicted time of a subsequent request for the streaming media content or a predicted time to request bandwidth allocation for the subsequent request; and
based on the output generated by the machine learning model, sending, by the communication device, a bandwidth allocation request to allocate bandwidth to transmit data in a wireless network.

9. The one or more non-transitory machine-readable media of claim 8, wherein the communication device provides network connectivity to a client device during playback of the streaming media content; and
wherein the series of requests comprises multiple requests for the streaming media content from the client device that are spaced apart in time, and wherein the set of feature values indicates a timing measure for each request in a group of consecutive requests from the series of requests, wherein the group of consecutive requests includes the request for the streaming media content from the client device issued most recently before generating the set of feature values.

10. The one or more non-transitory machine-readable media of claim 8, wherein the timing measure for a particular request comprises a measure of an amount of time that elapsed between the particular request and a reference time.

11. The one or more non-transitory machine-readable media of claim 10, wherein the reference time comprises a time of a first request for the streaming media content during a current session of playback of the streaming media content.

12. The one or more non-transitory machine-readable media of claim 11, wherein the timing measure for a particular request indicates an amount of time between the particular request for the streaming media content and the request for the streaming media content in the series of requests that occurs immediately prior to the particular request in the series of requests.

13. The one or more non-transitory machine-readable media of claim 8, wherein the set of features values indicates a timing measure for each of a predetermined number of consecutive requests in the most recently received request for the streaming media content.

14. The one or more non-transitory machine-readable media of claim 8, wherein the streaming media content is a video; and
wherein the communication device is configured to repeatedly predict the timing of future requests for content of the video during a session of playback of the video, including by:
detecting when requests for content of the video are issued; and
for each request detected, using the machine learning model to predict (i) a time that a next request for content of the video will be issued during the session of playback of the video or (ii) a time to send a next bandwidth allocation request.

15. A communication device comprising:
one or more processors; and
one or more non-transitory computer-readable media storing instructions that are operable, when executed by one or more processors of a communication device, to cause the communication device to perform operations comprising:
detecting, by the communication device, a series of requests for streaming media content;
generating, by the communication device, a set of feature values based on times that the requests for the streaming media content were issued;
providing, by the communication device, the set of feature values as input to a machine learning model, wherein the machine learning model has been trained to predict a time that a future request for media content will be issued based on input data indicating times that a sequence of previous requests for media content were issued;
receiving, by the communication device, output that the machine learning model generated based on input of the set of feature values, the output indicating a predicted time of a subsequent request for the streaming media content or a predicted time to request bandwidth allocation for the subsequent request; and
based on the output generated by the machine learning model, sending, by the communication device, a bandwidth allocation request to allocate bandwidth to transmit data in a wireless network.

16. The communication device of claim 15, wherein the communication device provides network connectivity to a client device during playback of the streaming media content; and
wherein the series of requests comprises multiple requests for the streaming media content from the client device that are spaced apart in time, and wherein the set of feature values indicates a timing measure for each request in a group of consecutive requests from the series of requests, wherein the group of consecutive requests includes the request for the streaming media content from the client device issued most recently before generating the set of feature values.

17. The communication device of claim 15, wherein the timing measure for a particular request comprises a measure of an amount of time that elapsed between the particular request and a reference time.

18. The communication device of claim 17, wherein the reference time comprises a time of a first request for the streaming media content during a current session of playback of the streaming media content.

19. The communication device of claim 18, wherein the timing measure for a particular request indicates an amount of time between the particular request for the streaming media content and the request for the streaming media content in the series of requests that occurs immediately prior to the particular request in the series of requests.

20. The communication device of claim 15, wherein the set of features values indicates a timing measure for each of a predetermined number of consecutive requests in the most recently received request for the streaming media content.
